(19) United States
(12) Patent Application Publication
(10) Pub. No.: US 2009/0085503 A1
(43) Pub. Date: Apr. 2, 2009

(54) On-vehicle LED illumination device

(75) Inventors: Takumi Narita, Aichi-ken (JP); Shinichiro Fuki, Aichi-ken (JP); Kazuhiro Sakai, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Nishikasugai-gun (JP)

(21) Appl. No.: 12/232,888

(22) Filed: Sep. 25, 2008

(30) Foreign Application Priority Data
Sep. 28, 2007 (JP) P.2007-253929

(51) Int. Cl. H05B 37/02

(52) U.S. Cl. 315/309

(57) ABSTRACT

An LED illumination device 1 for vehicle use includes an LED lamp 10, a circuit 5 for supplying a current to the LED lamp from a power supply mounted on the vehicle, and a current control unit 7 for controlling the current supplied to the LED lamp 10 so as to be inversely proportional to the environmental temperature of the LED lamp 10. In this manner, in the current supply circuit, an LED chip 11 is coupled to the collector of a common-emitter type transistor 15. The current control unit includes a PTC thermistor 21 and the PTC thermistor 21 is coupled to the base of the transistor 15, whereby a current supplied to the base is made small when the temperature of the PTC thermistor 21 becomes high. The PTC thermistor 21 is placed in a circumstance where the temperature thereof becomes same as the environmental temperature of the LED chip 11 at the time where the LED chip 11 is in an OFF state.

### BACKGROUND OF THE INVENTION

1. Field of the Invention

The present invention relates to an LED illumination device for vehicle use.

2. Description of the Related Art

In general, bulb type lamps have been employed as illumination devices for vehicle use such as room lamps, map lamps, reading lamps.

As a recent tendency, LED lamps have been noticed as light sources within vehicles in view of power saving, miniaturizing and light-weighting, and long living etc.

The documents disclosing the technique relating to the invention are a patent document 1 and a patent document 2.

Patent Document 1: JP-A-9-325719

Patent Document 2: JP-A-2007-87720

The inventors of the present application have concentrated on the investigation of LED lamps so as to utilize the LED lamp as a light source of an on-vehicle illumination device.

First, it is difficult to obtain, from a single current LED lamp, a light intensity almost same as that of a bulb-type lamp. One of the reasons is that when the environmental temperature of the LED lamp increases, the degradation of an LED chip is promoted and so the lifetime of the lamp is shortened.

In addition to the heat generated from the LED lamp itself and the heat generated from circuit parts (resistor etc.) of a circuit for supplying a current to the LED lamp, when the LED lamp is mounted on a vehicle, it is necessary to take the temperature increase due to the using environment of the vehicle into consideration. That is, in order to use the LED lamp as an on-vehicle illumination device, the LED lamp is required not to cause any trouble even if the vehicle is used under a burning scorching during the daytime and so the temperature of the vehicle body increases to a high temperature (80 to 100 degrees centigrade).

It is considered that in view of the usage under such the high-temperature environment, a current supplied to the LED lamp is made smaller than a rated current to thereby suppress an amount of heat generated from the LED lamp and hence maintain the lifetime thereof. However, a sufficient light intensity cannot be obtained from the LED lamp to which a small amount of current is supplied.

Although light intensity can be increased by increasing the number of the LED lamps to be disposed, such an idea is not practical since the number of parts increases and so the manufacturing cost also increases.

### SUMMARY OF THE INVENTION

The inventors of the present application have concentrated on the investigation of LED lamps so as to solve the aforesaid problems and found that since the inside of a vehicle is sufficiently bright under a burning scorching during the daytime, a user does not feel inconvenient even if the light intensity of an on-vehicle light emitting device is reduced. On the other hand, the inventors notified that a sufficient light intensity is required for the illumination device at night.

The used environmental temperature of the LED lamp is high during the daytime but low at night.

Thus, a current supplied to an LED lamp is controlled in accordance with the used environmental temperature of the LED lamp, whereby the light intensity (that is, a heating value) of the LED lamp is reduced under a burning scorching to thereby prevent the unnecessary degradation of the LED lamp, whilst the light intensity of the LED lamp is increased during night to thereby exert the original function thereof as an illumination device.

That is, the first aspect of the invention is defined as follows.

An LED illumination device for vehicle use, including:

an LED lamp;

a circuit which supplies a current to the LED lamp from a power supply mounted on the vehicle; and

a current control unit which controls the current supplied to the LED lamp so as to be inversely proportional to an environmental temperature of the LED lamp

According to the LED illumination device for vehicle use according to the first aspect defined in this manner, the current supplied to the LED lamp is inversely proportional to the environmental temperature of the LED lamp. Thus, the current supplied to the LED lamp is reduced under a burning scorching during the daytime at which the environmental temperature of the LED lamp is high to thereby prevent the overheating of the LED lamp. In contrast, the current supplied to the LED lamp is increased during the night at which the environmental temperature of the LED lamp is low to thereby generate a sufficient quantity of light from the LED lamp.

In this respect, the inversely proportional to the environmental temperature of the LED lamp in the current control unit represents that the supplied current is made small when the temperature becomes high and the supplied current is made large when the temperature becomes low, but does not necessarily represent that the relation is represented by a first-degree or linear equation or a plural degree equation. Further, since the excessive heating of the LED lamp becomes a problem when the environmental temperature thereof is high, the current control unit may perform the aforesaid function at least when the environmental temperature of the LED lamp is about 40 to 80 degrees centigrade or more.

The second aspect of the invention is defined as follows. That is, in the LED illumination device for vehicle use defined in the first aspect, in the current supply circuit, the LED lamp is coupled to a collector of a common-emitter type transistor, the current control unit includes a PTC thermistor and the PTC thermistor is coupled to a base of the transistor, whereby a current supplied to the LED lamp is made small when a temperature of the PTC thermistor becomes high.

According to the LED illumination device for vehicle use according to the first aspect defined in this manner, the LED lamp is incorporated into a current feedback bias circuit, whereby the current supplied to the LED lamp is stable even if the voltage of the power supply mounted on a vehicle varies. Further, the PTC thermistor is coupled between the base of the transistor and the power supply to thereby control the current supplied to the base in a manner that the current is made small when the temperature of the PTC thermistor becomes high, whilst the current is made large when the temperature of the PTC thermistor becomes low. Thus, the degradation of the LED lamp can be prevented and a sufficient quantity of light can be secured during night.

Further, as defined in the third aspect of the invention, the PTC thermistor is coupled in series between the power supply and the LED lamp, whereby a current supplied to the base may be made small when a temperature of the PTC thermistor becomes high.

Since such the configuration is simple, the manufacturing cost can be reduced.

In the aforesaid arrangement, preferably, the PTC thermistor is placed in a circumstance where the temperature thereof becomes same as the environmental temperature of the LED thermistor at the time where the LED lamp is in an OFF state.

The PTC thermistor can directly detect the environmental temperature of the LED lamp when the PTC thermistor is disposed near the LED lamp. However, in this case, since the environmental temperature of the LED lamp increases when the LED lamp is turned on, such the temperature increase undesirably influences on the PTC thermistor.

For example, as defined in the fourth aspect of the invention, the PTC thermistor is preferably disposed on the ceiling of the vehicle, where many LED lamps are disposed, at a position not thermally influenced by the LED lamp and other circuit elements (resistors etc.).

When the PTC thermistor is disposed near the LED lamp, a temperature setting value for controlling the current may be set so as to be higher by a value corresponding to the influence of the heat of the LED. That is, the PTC thermistor operates in a higher temperature region determined in view of the temperature increase by the heat, by taking the influence of the heat generated from the LED lamp and/or the circuit parts thereof into consideration.

The operation temperature of an excessive current protection circuit for controlling the current to the LED lamp is set to a temperature (80 to 100 degrees centigrade or more) close to the upper limit of the allowable temperature of the LED lamp itself.

In this manner, when the PTC thermistor is operated at the environmental temperature near that of the LED lamp, the LED lamp is prevented from being heated excessively.

### BRIEF DESCRIPTION OF THE DRAWINGS

FIG. 1 is a block diagram showing the configuration of an illumination device according to an embodiment of the invention.

FIG. 2 is a circuit diagram of the illumination device.

FIG. 3 is a diagram showing the characteristic curve of a PTC thermistor.

FIG. 4 is a diagram of the characteristic curve representing the relation between the temperature of the PTC thermistor and a current supplied to a LED chip.

FIG. 5 is a circuit diagram showing an illumination device according to another embodiment.

FIG. 6 is a circuit diagram showing an illumination device according to still another embodiment.

FIG. 7 is a circuit diagram showing an illumination device according to still another embodiment.

### DESCRIPTION OF THE PREFERRED EMBODIMENTS

Hereinafter, embodiments according to the invention will be explained with reference to drawings.

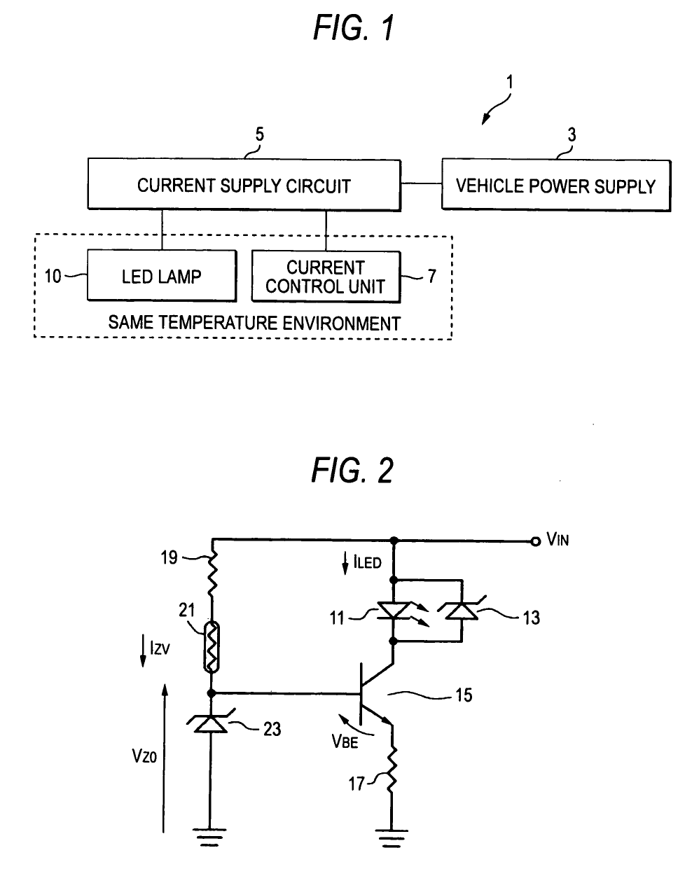

FIG. 1 is a block diagram showing the configuration of the illumination device 1 according to the embodiment.

The illumination device 1 according to the embodiment includes a current supply circuit 5 for supplying a stable current to an LED lamp 10 from a vehicle power supply 3 and a current control unit 7 for controlling a current supplied to the LED lamp 10 so as to be inversely proportional to the environmental temperature of the LED lamp 10.

Although the luminescent color of the LED lamp 10 can be selected arbitrarily, since the lamp emits white light in this embodiment, an LED chip (light source portion) is employed which is formed by combining a semiconductor light emitting element for outputting a short-waveform light or a blue light with a phosphor layer for converting the wavelength of the light emitted from the light emitting element. A III-group nitride compound semiconductor light emitting element is used preferably as the semiconductor light emitting element.

Although the type of the light-emitting element can also be selected arbitrarily, an SMD type for outputting blue light is used in this embodiment in order to secure a high rated current.

The phosphor layer may be selected suitably in accordance with the wavelength of the light emitted from the semiconductor light-emitting element. In this embodiment, Ce doped YAG phosphor is employed in correspondence to the blue light.

The number of the LED chips mounted on the LED lamp 10 can also be selected arbitrarily. In the case where a plurality of the LED chips are mounted, the color of the light emitted from the LED lamp 10 can be controlled when the colors of the lights emitted from the respective LED chips are differentiated and the light emission modes of the respective LED chips are controlled.

Such the LED chip is mounted on a board, then the board is fixed to a casing portion and the casing portion is attached to the interior portion of the vehicle. Lead wires coupled to the LED chip are exposed on the casing portion and the lead wires are coupled to the current supply circuit 5.

The LED lamp can be disposed at an arbitrary portion within the vehicle (including a trunk, a box etc.).

The current control unit 7 is disposed under the same temperature environment as the LED lamp 10 and acts on the current supply circuit 5 to control the current supplied to the LED lamp 10 in accordance with the temperature environment of the LED lamp 10.

As described later, in this embodiment, a PTC thermistor is incorporated within the current supply circuit, whereby the resistance value of the circuit is changed in accordance with the environmental temperature of the LED lamp 10 to thereby control the current supplied to the LED lamp 10. Of course, a temperature sensor may be used as the current control unit 7. By using an IC in accordance with the detection result of the temperature sensor, a variable resistor incorporated within the current supply circuit may be controlled.

The current control unit 7 (the PTC thermistor or the temperature sensor in the aforesaid explanation) is disposed under the same temperature environment as the LED lamp 10 in the OFF state of the LED lamp 10. That is, since the LED chip 10 generates heat when the LED lamp 10 is turned on, it is required not to influence the heat generation on the current control unit 7. More preferably, it is required not to influence heat generated from other circuit parts such as the resistor on the current control unit. If the heat generated from the LED lamp 10 influences on the current control unit 7, during night, for example, even if a large current (rated current) is supplied to the LED lamp 10 at the initial stage after the turning-on of the LED lamp 10, an amount of the current supplied to the LED lamp 10 from the current control unit 7 decreases in accordance with the increase of the environmental temperature, whereby the light intensity of the LED lamp 10 reduces undesirably.

In view of such a problem, it is preferable to dispose the current control unit 7 so as to be away from the LED lamp 10. However, in this case, the length of wirings etc. becomes long, which may cause the increase of the manufacturing cost.

The current supply circuit 5 includes a protection means for not only supplying a stable current to the LED lamp 10 from the vehicle power supply 3 but also preventing an excessive current from being applied to the LED lamp 10.

A not shown switch circuit can be provided between the current supply circuit 5 and the vehicle power supply 3. The switch circuit is controlled so as to be turned on and off in accordance with the opening/closing of a door, for example.

FIG. 2 shows a concrete circuit diagram of the illumination device 1 according to the embodiment.

In FIG. 2, a reference numeral 11 depicts the LED chip. The LED chip 11 is protected by a Zener diode 13. A power supply Vin supplies an LED current I_{LED} to the LED chip 11. The LED chip 11 is coupled to the collector of a common-emitter type transistor 15. The emitter of the transistor 15 is coupled to the vehicle body etc. via a first resistor 17 so as to be grounded.

A second resistor 19 and a PTC thermistor 21 are coupled in series between the base of the transistor 15 and the power supply Vin. A reference numeral 23 depicts a Zener diode for the circuit protection. The second resistor 19 and the PTC thermistor 21 may be coupled in parallel.

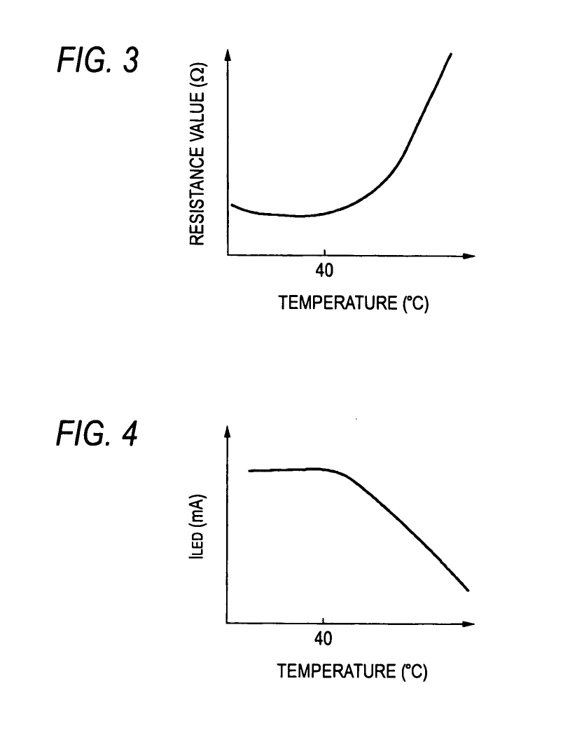

The PTC thermistor has temperature-resistance value characteristics shown in FIG. 3. That is, the resistance value increases almost in proportional to (or in a quadratic functional manner with respect to) the temperature in a temperature region of about 40 to 80 degrees centigrade or more.

In the circuit of FIG. 2, the LED current I_{LED} is represented almost by the following expression.

I_{LED}=(V_{ZD}−V_{BE})/R₁ (R₁ is the resistance value of the first resistor 17) (Expression 1)

A value of V_{ZD} reduces when the temperature of the PTC thermistor 21 increases and the resistance value thereof increases. As a result, a value of the numerator of the right side of the expression (1) becomes small (each of V_{BE} and R₁ is constant) and so a value of the LED current I_{LED} also becomes small.

In other words, since a Zener current flowing into the diode 23 becomes small when the temperature of the PTC thermistor 21 increases and the resistance value thereof increases, a value of V_{ZD} reduces. When a value of V_{ZD} reduces, since the terminal voltage R₁ across the resistor 17 becomes small, a value of I_{LED} is suppressed.

FIG. 4 shows an example of the relation between the LED current I_{LED} and the temperature of the PTC thermistor. From FIG. 4, it will be understood that the LED current I_{LED} is in inverse proportion to the temperature of the PTC thermistor in the temperature range of about 40 degrees centigrade or more.

According to the illumination device thus configured, when the temperature of the PTC thermistor 21 increases (that is, this means that the environmental temperature of the LED chip 11 has increased), a value of the LED current I_{LED} supplied to the LED chip 11 reduces due to the action of the transistor 15. On the other hand, when the temperature of the PTC thermistor 21 reduces (that is, this means that the environmental temperature of the LED chip 11 has reduced), a value of V_{ZD} increases and so a value of I_{LED} also increases. Thus, a rated current is supplied to the LED chip 11 in an intermediate high temperature range or the normal temperature range of about 40 degrees centigrade or less.

In this embodiment, the PTC thermistor 21 is employed which changes in its resistance value/temperature characteristics in a temperature region higher than about 60 degrees centigrade.

Since it is considered that the driving in such a high temperature range strongly influences on the durability of the LED chip, the characteristics required for the PTC thermistor 21 as a current control unit may be performed in such the temperature range.

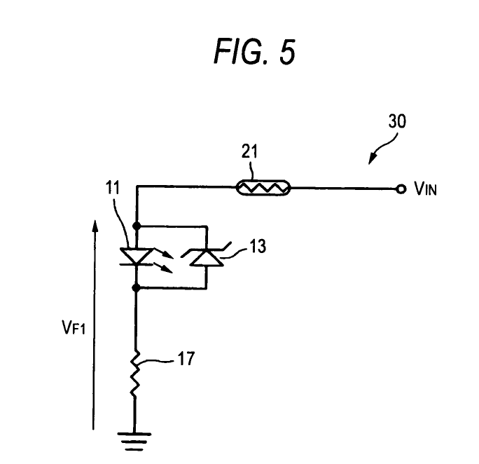

FIG. 5 shows the circuit configuration of an illumination device 30 according to another embodiment.

In the drawing, portions identical to those of FIG. 2 are referred to by the common symbols, with explanation thereof being omitted.

In this embodiment, the PTC thermistor 21 is coupled between the power supply Vin and the LED chip 11.

In such the circuit, the current I_{LED} supplied to the LED chip 11 is represented by the following expression:

I_{LED}=(Vin−V_{F1})/(R₁+R_{PTC}) (expression 2)

where, R₁ represents the resistance value of the resistor 17 and R_{PTC} represents the resistance value of the PTC thermistor 21.

As clear from the expression 2, when the temperature of the PTC thermistor 21 increases (this means that the environmental temperature of the LED chip 11 has increased), a resistance value R_{PTC} of the PTC thermistor 21 increases. Thus, a value of the denominator of the right side of the expression (2) increases and so a value of the LED current I_{LED} supplied to the LED chip 11 becomes small. On the other hand, when the temperature of the PTC thermistor 21 reduces (this means that the environmental temperature of the LED chip 11 has reduced), a resistance value R_{PTC} of the PTC thermistor 21 reduces. Thus, a value of the denominator of the right side of the expression (2) reduces and so a value of the LED current I_{LED} supplied to the LED chip 11 becomes large. As a result, since a large amount of the current, preferably, the rated current is supplied to the LED chip 11. The LED chip 11 can emit a large quantity of light.

According to the on-vehicle illumination devices of the respective embodiments configured in these manners, the rated current is supplied to the LED lamp at night during which the vehicle body is not heated thereby to secure a sufficient quantity of light at the LED lamp. Further, in contrast, when the temperature of the vehicle body increases to such a value that the environmental temperature of the LED lamp may influence on the lifetime of the LED lamp, the current supplied to the LED lamp is reduced thereby to prevent the heating of the LED lamp. In this case, although the light quantity of the LED lamp reduces, since such the high-temperature state arises during a burning scorching of the daytime, a user does not suffer inconvenience even if the light quantity of the LED lamp reduces. Further, since the LED is placed in a lightened state with a small current supplied thereto even in the high-temperature state, a user never doubts the lightened state of the LED.

Although it is possible to control an amount of the current supplied to the LED lamp by using an optical sensor, the optical sensor is expensive as compared with the PTC thermistor. That is, according to the embodiments, a cheap illumination device can be provided.

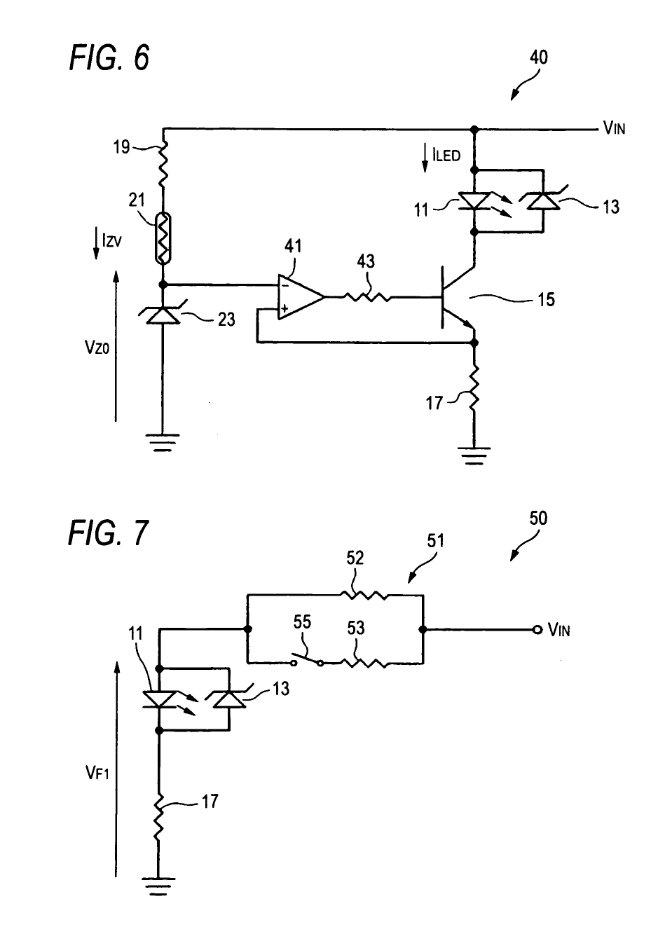

FIG. 6 shows an illumination device 40 according to another embodiment. In FIG. 6, portions identical to those of FIG. 2 are referred to by the common symbols, with explanation thereof being omitted.

The illumination device 40 of FIG. 6 is arranged in a manner that the PTC thermistor 21 is incorporated into a low-current circuit using an operational amplifier. In this circuit, a current I_{LED} supplied to the LED chip 11 is defined as follows:

I_{LED}=V_{ZD}/R₁ (expression 3)

where R₁ represents the resistance value of the resistor 17.

When the environmental temperature of the PTC thermistor 21 increases, since the resistance value of the PTC thermistor increases, a value of V_{ZD} becomes small. As a result, the current I_{LED} supplied to the LED chip 11 also becomes small. In this case, although the relation between the current I_{LED} and the environmental temperature of the PTC thermistor 21 is similar to that of FIG. 4, the inclination of the relation changes in accordance with the sensitivity of the operational amplifier.

FIG. 7 shows an illumination device 50 according to still another embodiment. In FIG. 7, portions identical to those of FIG. 5 are referred to by the common symbols, with explanation thereof being omitted.

The circuit shown in FIG. 7 is arranged in a manner that the PTC thermistor 21 in the circuit of FIG. 5 is replaced by a thermo switch portion 51. The thermo switch portion 51 is configured in a manner that a thermo switch 55 is connected in series with one of resistors 52, 53 that are coupled in parallel. The thermo switch 55 is in an OFF state when the temperature is a predetermined temperature (for example, 80 degrees centigrade) or less, whilst turned on when the temperature exceeds the predetermined temperature. Further, the thermo switch is always in a state of being capable of turning on at the predetermined temperature or less.

According to the illumination device 50 configured in this manner, when the environmental temperature of the thermo switch portion 51 acting as a current control unit exceeds the predetermined temperature, the thermo switch 55 is turned on and so the resistance value of the thermo switch portion 51 increases. Thus, a current supplied to the LED chip 11 is suppressed and so the LED chip 11 is prevented from being heated excessively.

That is, the illumination device 50 according to this embodiment is defined as follows:

the LED illumination device for vehicle use is characterized by including:

the LED lamp;

the circuit for supplying a current to the LED lamp from a power supply mounted on the vehicle; and

the current control unit for controlling the current supplied to the LED lamp when the environmental temperature of the LED lamp exceeds the predetermined temperature.

The invention is not limited to the explanation of the aforesaid modes and the embodiments according to the invention. The invention also contains various types of modified modes in a range not departing from the description of claims and a range easily thought by those skilled in the art.

What is claimed is:

1. An LED illumination device for vehicle use, comprising:
an LED lamp;
a circuit which supplies a current to the LED lamp from a power supply mounted on the vehicle; and
a current control unit which controls the current supplied to the LED lamp so as to be inversely proportional to an environmental temperature of the LED lamp.

2. The LED illumination device according to claim 1, wherein:
in the current supply circuit, the LED lamp is coupled to a collector of a common-emitter type transistor;
the current control unit includes a PTC thermistor; and
the PTC thermistor is coupled to a base of the transistor so that a current supplied to the LED lamp is made small when a temperature of the PTC thermistor becomes high.

3. The LED illumination device according to claim 1, wherein:
the current control unit includes a PTC thermistor; and
the PTC thermistor is coupled in series between the power supply and the LED lamp so that a current supplied to the base is made small when a temperature of the PTC thermistor becomes high.

4. The LED illumination device according to claim. 2, wherein:
the PTC thermistor is disposed on a ceiling of the vehicle at a position not thermally influenced by the LED lamp and other elements.

5. The LED illumination device according to claim 1, wherein:
the LED lamp is always supplied with current when the LED illumination device is in an ON state irrespective to the environmental temperature of the LED lamp.

6. The LED illumination device according to claim 2, wherein:
the PTC thermistor is disposed near the LED lamp.
